(19) United States
(12) Patent Application Publication
(10) Pub. No.: US 2006/0037827 A1
(43) Pub. Date: Feb. 23, 2006

(54) Hydraulic control system of automatic transmission

(76) Inventors: Hyeog June Lee, Yongin-city (KR); Jong Sool Park, Suwon-city (KR); Byung Kwan Shin, Suwon-city (KR); Jin Mo Park, Gwacheon-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/205,698

(22) Filed: Aug. 17, 2005

(30) Foreign Application Priority Data
Aug. 17, 2004 (KR) 10-2004-0064529

(51) Int. Cl. B60K 41/22

(52) U.S. Cl. 192/3.51

(57) ABSTRACT

A hydraulic control system of an automatic transmission includes broadening a control region of the transmission. In the hydraulic control system, a frictional element control pressure, for controlling a frictional element, is changed from a solenoid control pressure to a line pressure corresponding to a change of an open/closed state of a corresponding port of a valve.

### CROSS-REFERENCE TO RELATED APPLICATION

This application claims priority to and the benefit of Korean Patent Application 10-2004-0064529 filed in the Korean Intellectual Property Office on Aug. 17, 2004, the entire content of which is incorporated herein by reference.

1. Technical Field of the Invention

The present invention relates to a hydraulic control system of an automatic transmission for a vehicle.

2. Background of Related Art

Typically, in order to improve fuel mileage and provide better driving performance of an automatic transmission, the automatic transmission is required to undergo a greater number of speeds shifts and to have a bigger capacity.

A conventional hydraulic control method for an automatic transmission has a switching characteristic of blocking a feedback pressure of a pressure control valve PCV. However, this system has a drawback in that a spring force of a switching valve SWV becomes excessively large. Additionally, in the conventional art, a pressure equal to or less than 4˜5 kgf/cm² is needed in order to control a frictional element of the transmission, such as, a brake or a clutch, during shifting. Furthermore, a greater pressure is needed in order to endure a maximum torque. Therefore, the hydraulic pressure range is available only in a limited range if the pressure control valve PCV is designed on the basis of the maximum torque.

The information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide hydraulic control that is more precisely performed by broadening a control region due to an improvement of a hydraulic control method.

In an exemplary hydraulic control system according to an embodiment of the present invention, a frictional element control pressure for controlling a frictional element is changed from a solenoid control pressure to a line pressure corresponding to a change of an open/closed state of a corresponding port.

### BRIEF DESCRIPTION OF THE DRAWINGS

FIGS. 1 and 2 show a hydraulic control system of an automatic transmission for a vehicle according to an embodiment of the present invention; and

FIG. 3 shows a relationship between a shifting pressure and a solenoid control pressure.

### DETAILED DESCRIPTION OF THE EMBODIMENTS

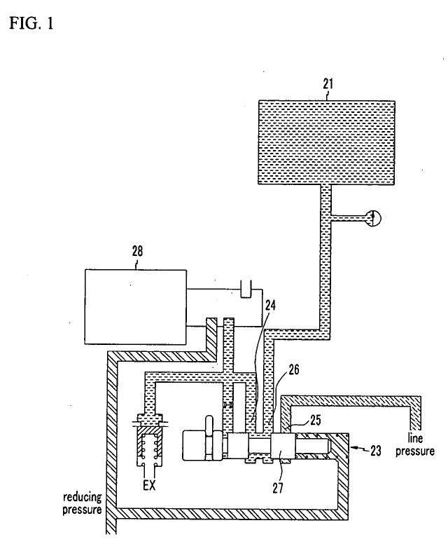

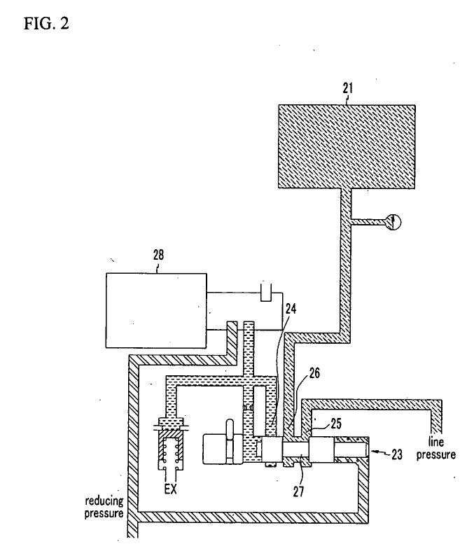

Referring to FIGS. 1 and 2, a hydraulic control system of an automatic transmission includes a system using a multistage control method. The multistage control includes a frictional element control pressure for controlling a frictional element, such as a clutch or a brake. According to a preferred embodiment, the control pressure includes a line pressure.

The frictional element control pressure is a hydraulic pressure for controlling an operation of a frictional element 21. As is well known in the art, the frictional element 21 can be a clutch, a brake, or the like. That is, according to an embodiment of the present invention, a frictional element control pressure utilizes a line pressure corresponding to a change of an open/closed state of a corresponding port.

FIGS. 1 and 2 show a hydraulic control system according to an exemplary embodiment of the present invention. The control system includes a valve 23 for controlling a hydraulic pressure supplied to the frictional element 21. A plurality of ports 24, 25, and 26 are formed in a valve body 23 of the valve 23, and a valve spool 27 is disposed within the valve body.

A solenoid control pressure, which is discharged from a solenoid valve 28, is supplied to the valve 23 through the port indicated by reference numeral 24, and a line pressure is supplied to the valve 23 through the port indicated by reference numeral 25. For example, the solenoid valve 28 may be a variable force solenoid valve.

In an embodiment of the present invention, the ports 24 and 25 can be selectively opened or closed corresponding to a change of position of the valve spool 27. That is, if the valve spool 27 is located at a position shown in FIG. 1, the port 24 is at least partially opened and the port 25 is closed, and on the other hand, if the valve spool 27 is located at a position shown in FIG. 2, the port 24 is closed and the port 25 is at least partially opened.

Accordingly, the solenoid control pressure is supplied as a frictional element control pressure for controlling the frictional element 21 through the port 26 in a state of FIG. 1, and the line pressure is supplied as a frictional element control pressure for controlling the frictional element 21 through the port 26 in a state of FIG. 2. Therefore, according to an embodiment of the present invention, the frictional element control pressure is changed from the solenoid control pressure to the line pressure corresponding to a change of position of the valve spool 27 that causes a change of open/closed state of the corresponding ports 24 and 25.

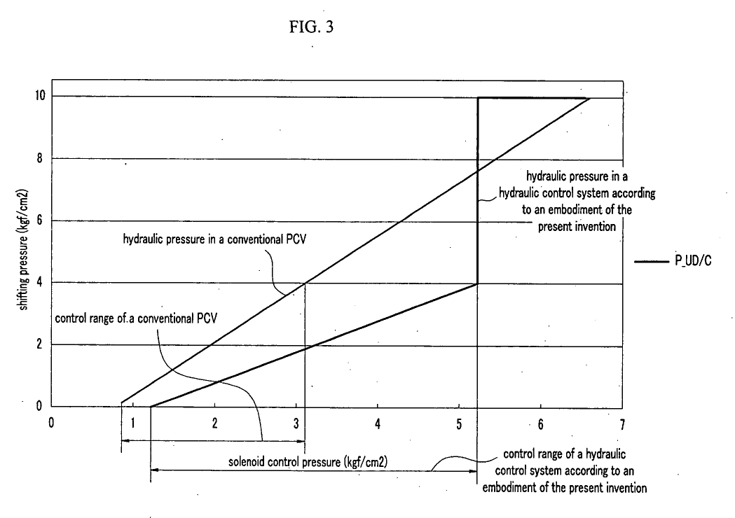

Referring now to FIG. 3, a relationship between a shifting pressure and a solenoid control pressure is shown. A hydraulic control scheme of the hydraulic control system according to an embodiment of the present invention is a multistage control scheme in which a control pressure for the clutch and the brake is controlled initially by the solenoid control pressure and subsequently by the line pressure. A control region of the hydraulic control system according to an embodiment of the present invention has been broadened when compared to that of a conventional pressure control valve.

Therefore, the hydraulic control system according to an embodiment of the present invention can realize a broadened control region when compared to the conventional art, so that more precise hydraulic control can be achieved.

According to an embodiment of the present invention, phased control, i.e., multistage control of the frictional element control pressure sequentially using the solenoid control pressure and the line pressure is possible, and in addition, the number of valves can be decreased by one when compared to the conventional art because a pressure control valve can be removed due to the phased pressure control. For example, a port that is repeated among the conventional pressure control valves can be removed, so that the overall system can be simplified.

The hydraulic control system according to an embodiment of the present invention has a switching characteristic such that the control pressure for the frictional elements is controlled with the solenoid control pressure and is subsequently controlled with the line pressure, which can reduce a leak problem and simplify a hydraulic system due to a reduction of the number of valves through a removal of the pressure control valve PCV and therefore reduce the manufacturing cost.

The hydraulic control system according to an embodiment of the present invention can perform more precise shift control due to the broadening of the hydraulic control region. In addition, with the hydraulic control system according to an embodiment of the present invention, the number of valves can be reduced when compared to the conventional hydraulic system, so that overall weight thereof can be reduced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A hydraulic control system for an automatic transmission, wherein a frictional element control pressure for controlling a frictional element is changed from a solenoid control pressure to a line pressure corresponding to a change of an open/closed state of a corresponding port.

2. A hydraulic control system for an automatic transmission, comprising:
a frictional element controlled by a frictional control pressure; and
a valve capable of outputting a solenoid pressure or a line pressure;
wherein the frictional control pressure for controlling the frictional element is controlled by the solenoid pressure or the line pressure outputted by the valve.

3. The hydraulic control system of claim 2, wherein the valve is capable of outputting a mixture of the solenoid pressure and the line pressure.

4. A method for controlling an automatic transmission, comprising:
controlling a valve between outputting a solenoid pressure and outputting a line pressure; and
applying a control pressure to a frictional element, wherein the control pressure is either the outputted solenoid pressure or the outputted line pressure.
